(19) United States
(12) Patent Application Publication
(10) Pub. No.: US 2024/0187049 A1
(43) Pub. Date: Jun. 6, 2024

(54) Method and System for Decoding a Signal at a Receiver in a Multiple Input Multiple Output (MIMO) Communication System

(71) Applicant: Nokia Technologies Oy, Espoo (FI)

(72) Inventors: Pavan Koteshwar Srinath, Orsay (FR); Karthik KUNTIKANA SHRIKRISHNA, Bangalore (IN)

(21) Appl. No.: 18/284,325

(22) PCT Filed: Mar. 16, 2022
(86) PCT No.: PCT/EP2022/056816

§ 371 Date: Sep. 27, 2023

(30) Foreign Application Priority Data
Mar. 31, 2021 (FI) 20215383

(51) Int. Cl. H04B 7/0456; H04L 25/03

(52) U.S. Cl. CPC H04B 7/0456; H04L 25/03165; H04L 2025/03464

(57) ABSTRACT

A method and an apparatus for decoding a signal at a receiver in a MIMO communication system is described. A signal y is obtained over a channel from a plurality of transmitters in communication with the receiver, the signal y includes data signals transmitted on a plurality of layers N. A concatenated matrix R representing the channel between the plurality of transmitters and the receiver is obtained based on an estimated channel matrix H. An ordered list [symbol] is determined based at least on the signal y and the obtained concatenated matrix R. The ordered list is a list of N-dimensional vectors and each vector is a candidate constellation point for the transmitted data signal based on a predefined metric, and is determined using a list search block configured to implement a machine learning algorithm.

### TECHNICAL FIELD

Various embodiments relate to a method and system for decoding a signal at a receiver in a multiple input multiple output (MIMO) communication system.

### BACKGROUND

Current communication systems require efficient utilization of radio frequency spectrum in order to increase achievable data-rate within a given transmission bandwidth. Typically, each successive generation of communication systems aims at ultra-high throughput, seamless connectivity, and/or low latency. This can be accomplished by employing multiple transmit and receive antennas combined with signal processing and simultaneous communication with multiple users, each having multiple spatial streams or layers. This is possible with the advent of 4G, massive MIMO (mMIMO) and 5G, which results in enhanced spectral efficiency. However, the use of multiple transmitting and receiving antennas results in multi-user interference. Thus, combating the multi-user interference using an efficient implementation becomes essential. In order to reduce multi-user interference, efficient and robust multi-user MIMO (MU-MIMO) signal detection algorithms are used. The MU-MIMO signal detection algorithms multiply the capacity of a radio link using multiple transmitting and receiving antennas to exploit multipath propagation. By exploiting the multipath propagation, MU-MIMO facilitates transmitting and receiving more than one data signal simultaneously over the same radio channel.

Further, in a communication system comprising a transmitter and a receiver, an RF modulated signal from the transmitter may reach the receiver via a number of propagation paths. The characteristics of the propagation paths typically vary over time due to a number of factors such as fading and multipath, resulting in interference. Further, to combat the interference effectively, joint receiver techniques such as maximum likelihood detection (MLD), are used to facilitate high spectral efficiency.

Furthermore, the MU-MIMO signal detection algorithms are used to combat interference at a receiver side of the communication systems. While dealing with interference, the MU-MIMO signal detection algorithms exhibit a trade-off between performance and computational complexity. Traditional MU-MIMO signal detection algorithms are linear and provide sub-optimal performance These traditional MU-MIMO signal detection algorithms may comprise at least one of Maximal Ratio Combining (MRC), Zero Forcing (ZF), or Linear Minimum Mean Square Error (LMMSE) estimator. However, the propagation paths between the transmitting and receiving antennas are linearly independent (i.e., a transmission on one path is not a linear combination of the transmissions on the other paths), thus the likelihood of correctly receiving a data transmission increases as the number of antennas increases. However, this adds to the computational complexity at the receiver side of the communication systems. Further, linear detectors like MRC, ZF, and LMMSE detectors do not provide a good error performance except under very specific channel conditions. The difference in the performance of these detectors from that of an optimal detector is quite significant under most channel conditions, sometimes up to several decibels (dB). Further, the optimal detector, which employs a joint decoding algorithm, is significantly more complex. Further, sphere decoding is one appealing technique that performs MLD techniques, however, sphere decoding is not practical for commercial implementation of MU-MIMO communication systems. The number of computations performed in MLD techniques is quite high.

The receivers in the MU-MIMO communication system are expected to output soft information (log-likelihood ratios) about the bits that are decoded. An exact MLD soft-output sphere decoder (depth first approach) detects all layers from the transmitting user equipments (UEs), jointly, in a communication system. However, when the number of data streams is large, a single decoding phase takes a long duration which makes it impractical for commercial use. Using the MLD rule, the detector outputs the log-likelihood ratios (LLRs) which are used as inputs to the channel decoder. However, such a rule increases the complexity when the number of UEs/layers/data streams is large.

Further, a non-MLD fixed complexity soft-output sphere decoder (depth first approach) limits the number of computations to decode all the layers corresponding to the UEs, resulting in fixed complexity. However, this approach suffers from severe degradation of mMIMO systems with practical channel conditions. Additionally, there is no general rule on how to limit the number of computations for a defined mMIMO configuration.

In order to combat the above discussed problems of the communication systems, a K-best sphere decoder (breadth-first approach) is currently used at the receiver side of the communication systems, as disclosed in FIG. 1. This approach is based on a breadth first approach, which results in choosing K number of candidates in each layer as survivors. Further, for N users (transmitters) in a communication system, which are transmitting at the same time, the K-best sphere decoder processes the transmitted signal at N layers corresponding to the N users. A K-best decoding algorithm begins at layer N, at 102 and sequentially progresses to layers N−1, N−2, . . . 1. The transmitted signal is processed at each layer and each layer passes a K number of survivors to the next layer. This approach fixes the required computations, however, there is no flexibility in changing the value of K at each layer. Further, at each layer, M distances are computed for K survivors of the previous layer, at 104-1, 104-2, . . . 104 N_{U}. The K survivors refer to the partial symbol vectors of the transmitted signal. For a QAM constellation of size M, the K survivors are selected by calculating a total of KM distances. The K survivors are sorted and chosen, at 106. The sorted K survivors then progress to the subsequent layer N−2. Further, the process is repeated till the K survivors reach layer 1. In one embodiment, the layer 1 is referred to as the final layer or the last layer. Finally, the K survivors of the final layer provide the required ordered list. It should be noted that in the K best sphere decoding algorithm, the value of K is the same for each layer and needs to be sufficiently large for near-optimal detection.

Thus, the disadvantage of K-best decoder is that the value of K is fixed for each layer and needs to be sufficiently large. This results in added complexity at the receiver side of the communication system. Hence there is a need for a reduced computational complexity at the receiver side of the communication system. However, a reduced complexity receiver which provides near-optimal error performance for all channel conditions has not been considered for the MU-MIMO communication systems. Therefore, there is a need for an improved method and receiver for decoding a signal in the MU-MIMO communication system, in order to provide near-optimal error performance along with practical commercial implementation.

### SUMMARY

The present disclosure addresses the above object by the subject-matter covered by the independent claims. Preferred embodiments of the invention are defined in the dependent claims.

According to a first aspect of the invention, there is provided a receiver of a multiple input multiple output, MIMO, communication system. The receiver may comprise means for obtaining a signal y over a channel from a plurality of transmitters in communication with the receiver, wherein the signal y comprises data signals transmitted on a plurality of layers N, means for obtaining a concatenated matrix R, representing the channel between the plurality of transmitters and the receiver, wherein the concatenated matrix R is obtained based on an estimated channel matrix H, and means for determining an ordered list [symbol] , based at least on the signal y and the obtained concatenated matrix R, wherein the ordered list is a list of N-dimensional vectors and each vector is a candidate constellation point for the transmitted data signal based on a predefined metric. In one embodiment, the transmitted plurality of data signals is a vector of constellation points. In one embodiment, the means for determining the ordered list [symbol] comprises a List Search Block (LSB), wherein the LSB is configured to implement a Machine Learning (ML) algorithm. The usage of the LSB improves the receiver performance in terms of block error rate (BLER) using low decoding latency and hardware power consumption.

In one embodiment, the concatenated matrix R may be obtained by a QR decomposition of the estimated channel matrix H.

In some embodiments of the present invention, the means for determining the ordered list [symbol] may further comprise means for determining an ordered list [symbol] _{N}, at a root layer of the plurality of layers N, and means for determining a plurality of ordered lists [symbol] ₗ for the other layers of the plurality of layers N, wherein each ordered list SS/being determined may be based on an ordered list [symbol] ₗ₊₁, where l=N−1, N−2, . . . 1.

In some embodiments of the present invention, the means for determining the ordered list [symbol] _{N}, at the root layer, may comprise means for obtaining one or more input parameters, wherein the one or more input parameters may comprise at least an N^{th} element of the signal y, a constellation size M, and a required number of surviving candidates K_{N}, means for determining a plurality of partial symbol vectors, wherein the determined partial symbol vectors are the K_{N} surviving candidates for the root layer, based at least on the one or more input parameters, means for determining a first smallest possible window using a trained ML model, wherein the first smallest possible window comprises a plurality of constellation points K′_{N} for a signal y′ derived from N^{th} element of the signal y, wherein the plurality of constellation points K′_{N} may comprise the K_{N} closest constellation points to the signal y′, means for determining partial Euclidean distances (PEDs) between the signal y′ and each of the plurality of constellation points K′_{N} in the first smallest possible window, and means for sorting the plurality of the K′_{N} constellation points based on the determined PEDs and thereby determining the ordered list [symbol] _{N}. In one embodiment, the K_{N} surviving candidates may refer to one or more survivors in root layer i.e. layer N. The usage of pre-trained ML block eliminates the need to calculate the distance to all the M constellation points. Such a use of the pre-trained ML block facilitates the reduction in computation complexities.

In some embodiments of the present invention, the determined partial Euclidean distances associated with the plurality of constellation points K′_{N} in the ordered list [symbol] _{N}, may be stored in a list [symbol] _{N}.

In some embodiments of the present invention, the first smallest possible window for the K_{N} surviving candidates is represented by a class indicated by integers L_{y}, R_{y}, B_{y}, and T_{y}, wherein L_{y} represents the number of constellation points to the left of the closest constellation point in the smallest possible window, R_{y} represents the number of constellation points to the right of the closest constellation point in the smallest possible window, B_{y} represents the number of constellation points to the bottom of the closest constellation point in the smallest possible window, and T_{y} represents the number of constellation points to the top of the closest constellation point in the smallest possible window.

In some embodiments of the present invention, the means for determining the ordered lists [symbol] ₗ, for the other layers of the plurality of layers may comprise means for obtaining one or more input parameters, wherein the one or more input parameters comprise at least an l^{th} element of the signal y, the constellation size M, and a required number of surviving candidates Kₗ for layer l, where l=N−1, N−2, . . . 1, means for obtaining an ordered list [symbol] ₗ and a list [symbol] ₗ from the surviving candidate in the ordered list [symbol] ₗ₊₁, where l=N−1, N−2, . . . 1, means for determining the closest constellation point for each surviving candidate in the ordered list [symbol] ₗ₊₁, means for determining a partial symbol vector for each determined closest constellation point, means for determining partial Euclidean distances (PEDs) based on the determined partial symbol vectors, means for sorting the ordered list [symbol] ₗ₊₁ wherein the ordered list [symbol] ₗ₊₁ is sorted in ascending order of determined PEDs, means for determining a smallest possible window using the trained ML model, for each element in the sorted ordered list [symbol] ₗ₊₁, wherein the smallest possible window comprises a plurality of constellation points K_{l,i}, where i=1, 2, . . . , Kₗ₊₁, means for determining partial Euclidean distances (PEDs) between a function of l^{th} element of the signal y and each of the K_{l,i} constellation points, and means for sorting the plurality of K_{l,i} constellation points in the smallest possible window based on the determined PEDs; and thereby determining the ordered list [symbol] ₗ.

In some embodiments of the present invention, the determined partial Euclidean distances associated with the plurality of constellation points K_{l,i} in the ordered list [symbol] ₗ, may be stored in a list [symbol] ₗ, where l=N−1, N−2, . . . , 1.

Further, the smallest possible window for the Kₗ surviving candidates is represented by a class indicated by integers L_{y′}, R_{y′}, B_{y′}, and T_{y′}, wherein L_{y′} represents a number of constellation points to the left of the closest constellation point in the smallest possible window, R_{y′} represents a number of constellation points to the right of the closest constellation point in the smallest possible window, B_{y′} represents a number of constellation points to the bottom of the closest constellation point in the smallest possible window, and T_{y′} represents a number of constellation points to the top of the closest constellation point in the smallest possible window.

In some embodiments of the present invention, the receiver may comprise means for performing Log-Likelihood ratio (LLR) computation on the determined ordered list [symbol] . The receiver may further comprise means for pre-processing the signal y using one or more pre-processing techniques, wherein the one or more pre-processing techniques comprise at least noise-whitening technique and QR decomposition technique.

In another embodiment, the receiver may be configured to train the ML model based at least on a training data set with input features which are functions of a one-dimensional complex-valued signal y, the constellation size M, and the number of surviving candidates K_{N}.

In accordance with another embodiment, a multi-user multiple input multiple output, MU-MIMO, communication system comprising a plurality of transmitters, a receiver, and a MIMO channel may be disclosed. The receiver may comprise means for obtaining a signal y over a channel, from a plurality of transmitters in communication with the receiver, wherein the signal y comprises data signals transmitted on a plurality of layers N; means for obtaining a concatenated matrix R, representing the channel between the plurality of transmitters and the receiver, wherein the concatenated matrix R is obtained based on an estimated channel matrix H, and means for determining an ordered list [symbol] , based at least on the signal y and the obtained concatenated matrix R, wherein the ordered list is a list of N-dimensional vectors and each vector is a candidate constellation point for the transmitted data signal based on the predefined metric, the determining the ordered list [symbol] may comprise a List Search Block (LSB), wherein the LSB is configured to implement a Machine Learning (ML) algorithm. The usage of the LSB improves the receiver performance in terms of block error rate (BLER) using low decoding latency and hardware power consumption.

Further, the concatenated matrix R may be obtained by a QR decomposition of the estimated channel matrix H.

The receiver may comprise means for determining the ordered list [symbol] which further comprises means for determining an ordered list [symbol] _{N}, at a root layer of the plurality of layers N, and means for determining a plurality of ordered lists [symbol] ₗ for other layers of the plurality of layers N, wherein each ordered list [symbol] ₗ being determined may be based on the ordered list [symbol] ₗ₊₁, where l=N−1, N−2, . . . 1.

In some embodiments of the present invention, the means for determining the ordered list [symbol] _{N}, at the root layer, may comprise means for obtaining one or more input parameters, wherein the one or more input parameters may comprise at least an N^{th} element of the signal y, the constellation size M, and a required number of surviving candidates K_{N}, means for determining a plurality of partial symbol vector, wherein the determined partial symbol vector are the K_{N} surviving candidates for the root layer, based at least on the one or more input parameters, means for determining a first smallest possible window using a trained ML model, wherein the first smallest possible window comprises a plurality of constellation points K′_{N} for a signal y′ derived from N^{th} element of the signal y, wherein the plurality of constellation points K′_{N} may comprise the K_{N} closest constellation points to the signal y′, means for determining partial Euclidean distances (PEDs) between the signal y′ and each of the plurality of constellation points K′_{N} constellation points in the first smallest possible window, and means for sorting the plurality of constellation points K′_{N} based on the determined PEDs, and thereby determining the ordered list [symbol] _{N}. In one embodiment, the K_{N} surviving candidates may refer to one or more survivors in root layer i.e. layer N. In another embodiment, the Kₗ surviving candidates may refer to one or more survivors in layer l. The usage of pre-trained ML block eliminates the need to calculate the distance to all the M constellation points. Such a use of the pre-trained ML block facilitates the reduction in computation complexities.

In some embodiments of the present invention, the determined partial Euclidean distances associated with plurality of constellation points K′_{N} in the ordered list [symbol] _{N}, may be stored in a list [symbol] N_{N}.

Further, the first smallest possible window for the K_{N} surviving candidates is represented by a class indicated by integers L_{y}, R_{y}, B_{y}, and T_{y}, wherein L_{y} represents a number of constellation points to the left of the closest constellation point in the smallest possible window, R_{y} represents a number of constellation points to the right of the closest constellation point in the smallest possible window, B_{y} represents a number of constellation points to the bottom of the closest constellation point in the smallest possible window, and T_{y} represents a number of constellation points to the top of the closest constellation point in the smallest possible window.

In some embodiments of the present invention, the means for determining the ordered lists [symbol] ₗ, for the other layers of the plurality of layers may comprise means for obtaining one or more input parameters, wherein the one or more input parameters comprise at least an l^{th} element of the signal y, a constellation size M, and a required number of surviving candidates Kₗ for layer l, where l=N−1, N−2, . . . 1, means for obtaining an ordered list [symbol] ₗ and a list [symbol] ₗ, from the surviving candidate in the ordered list [symbol] ₊₁, where l=N−1, N−2, . . . 1, means for determining a closest constellation point for each surviving candidate in the ordered list [symbol] ₗ₊₁, means for determining a partial symbol vector for each determined closest constellation point, means for determining partial Euclidean distances (PEDs) based on the determined partial symbol vectors, means for sorting the ordered list [symbol] ₊₁, , wherein the ordered list [symbol] ₊₁, is sorted in ascending order of determined PEDs, means for determining a smallest possible window, using the trained ML model, for each element in the sorted ordered list [symbol] ₊₁, wherein the smallest possible window comprises a plurality of constellation points K_{l,i}, wherein i=1, 2, . . . , Kₗ₊₁, means for determining partial Euclidean distances (PEDs) between a function of the l^{th} element of the signal y and each of the constellation points K_{l,i} and means for sorting the plurality of constellation points K_{l,i} in the smallest possible window based on the determined PEDs; and thereby determining the ordered list [symbol] ₗ.

In some embodiments of the present invention, the determined partial Euclidean distances associated with the plurality of constellation points K_{l,i} in the ordered list [symbol] ₗ, may be stored a list [symbol] ₗ. Further, the smallest possible window of the plurality of Kₗ surviving candidates is represented by a class indicated by integers L_{y′}, R_{y′}, B_{y′}, and T_{y′}, wherein L_{y′} represents a number of constellation points to the left of the closest constellation point in the smallest possible window, R_{y′} represents a number of constellation points to the right of the closest constellation point in the smallest possible window, B_{y′} represents a number of constellation points to the bottom of the closest constellation point in the smallest possible window, and T_{y′} represents a number of constellation points to the top of the closest constellation point in the smallest possible window.

In some embodiments of the present invention, the receiver may comprise means for performing Log-Likelihood ratio (LLR) computation on the determined ordered list [symbol] . The receiver may further comprise means for pre-processing the signal y using one or more pre-processing techniques, wherein the one or more pre-processing techniques comprise at least noise-whitening technique and QR decomposition technique.

In another embodiment, the receiver may be configured to train the ML model based at least on a training data set with input features which are functions of a one-dimensional complex-valued signal y, the constellation size M, and the number of surviving candidates K_{N}.

According to a second aspect of the present invention, a method for decoding a signal y at a receiver in a multiple input multiple output, MIMO, communication system, may be disclosed.

The method may comprise, obtaining the signal y over a channel from a plurality of transmitters in communication with a receiver, wherein the signal y comprises data signals transmitted on a plurality of layers N, obtaining a concatenated matrix R, representing the channel between the plurality of transmitters and the receiver, wherein the concatenated matrix R is obtained based an estimated channel matrix H, and determining an ordered list [symbol] , based at least on the signal y and the obtained concatenated matrix R, wherein the ordered list is the list of N-dimensional vectors and each vector is a candidate constellation point for the transmitted data signal based on the predefined metric, wherein the determining the ordered list [symbol] may comprise a List Search Block (LSB), wherein the LSB is configured to implement a Machine Learning (ML) algorithm The usage of the LSB improves the receiver performance in terms of block error rate (BLER) using low decoding latency and hardware power consumption.

In one embodiment, the method wherein the concatenated matrix R is obtained by a QR decomposition of the estimated channel matrix H.

The method may further comprise determining an ordered list [symbol] _{N}, at a root layer of the plurality of layers N, and means for determining a plurality of ordered lists [symbol] ₗ for other layers of the plurality of layers N, wherein each ordered list [symbol] ₗ being determined may be based on the ordered list [symbol] ₗ₊₁, where l=N−1, N−2, . . . 1.

The method wherein determining the ordered list [symbol] _{N}, at the root layer, may comprise means for obtaining one or more input parameters, wherein the one or more input parameters may comprise at least an N^{th} element of the signal y, the constellation size M, and a required number of surviving candidate K_{N}, means for determining a plurality of partial symbol vector, wherein the determined partial symbol vector are the K_{N} surviving candidates for the root layer, based at least on the one or more input parameters, means for determining a first smallest possible window using a trained ML model, wherein the first smallest possible window comprises a plurality of constellation points K′_{N} for a signal y′ derived from N^{th} element of the signal y, wherein the plurality of constellation points K′_{N} may comprise the K_{N} closest constellation points to the signal y′, means for determining partial Euclidean distances (PEDs) between the signal y′ and each of plurality of constellation points K′_{N} in the first smallest possible window, and means for sorting the plurality of constellation points K′_{N} based on the determined PEDs, and thereby determining the ordered list [symbol] _{N}. In one embodiment, the K_{N} surviving candidates may refer to one or more survivors in root layer i.e. layer N. The usage of pre-trained ML block eliminates the need to calculate the distance to all the M constellation points. Such a use of the pre-trained ML block facilitates the reduction in computation complexities.

The method may further comprise the partial Euclidean distances (PEDs) associated with the plurality of constellation points K′_{N} in the ordered list [symbol] _{N}, may be stored in a list [symbol] _{N}.

The method wherein determining the ordered lists [symbol] ₗ, for the other layers of the plurality of layers N, may comprise, obtaining one or more input parameters, wherein the one or more input parameters comprise at least an l^{th} element of the signal y, a constellation size M, and a required number of Kₗ surviving candidates for layer l, where l=N−1, N−2, . . . 1, means for obtaining an ordered list [symbol] ₗ and a list [symbol] ₗ, where l=N−1, N−2, . . . 1, means for determining a closest constellation point for each surviving candidate in the ordered list [symbol] ₗ₊₁, means for determining a partial symbol vector for each determined closest constellation point, means for determining partial Euclidean distances (PEDs) based on the determined partial symbol vectors, means for sorting the ordered list [symbol] ₗ₊₁, wherein the ordered list [symbol] ₗ₊₁ is sorted in ascending order of determined PEDs, means for determining a smallest possible window, using the trained ML model, for each element in the sorted ordered list [symbol] ₗ₊₁, wherein the smallest possible window comprises a plurality of constellation points K_{l,i} wherein i=1, 2, . . . , Kₗ₊₁, means for determining partial Euclidean distances (PEDs) between a function of the l^{h} element of the signal y and each of the plurality of constellation points K_{l,i} and means for sorting the plurality of constellation points K_{l,i} in the smallest possible window based on the determined PEDs; and thereby determining the ordered list [symbol] ₗ.

In some embodiments of the present invention, the determined partial Euclidean distances associated with the plurality of constellation points K_{l,i} in the ordered list [symbol] ₗ, may be stored in a list [symbol] ₗ, where l=N−1, N−2, . . . ,1.

In one embodiment, the determined partial Euclidean distances associated with the plurality of constellation points K_{l,i} in ordered list [symbol] ₗ may be stored in a list [symbol] ₗ, where l=N−1, N−2, . . . ,1. Further, the smallest possible window for the Kₗ surviving candidates is represented by a class indicated by integers L_{y′}, R_{y′}, B_{y′}, and T_{y′}, wherein L_{y′} represents a number of constellation points to the left of the closest constellation point in the smallest possible window, R_{y′} represents a number of constellation points to the right of the closest constellation point in the smallest possible window, B_{y′} represents a number of constellation points to the bottom of the closest constellation point in the smallest possible window, and T_{y′} represents a number of constellation points to the top of the closest constellation point in the smallest possible window.

In one embodiment, the method may comprise performing Log-Likelihood ratio (LLR) computation on the determined ordered list [symbol] . The method may further comprise pre-processing the signal y using one or more pre-processing techniques, wherein the one or more pre-processing techniques comprise at least noise-whitening technique and QR decomposition technique.

In another embodiment, the ML model may be trained based at least on a training data set which are functions of a one-dimensional complex-valued signal y, the constellation size M and the required number of surviving candidates K_{N}.

According to a third aspect of the present invention, a non-transitory computer-readable medium may be disclosed. The non-transitory computer-readable medium may comprise instructions for causing a processor to perform functions for optimization of signal shaping in multi-user multiple input multiple output (MU-MIMO) communication system. The non-transitory computer-readable medium may comprise instructions for causing a processor to perform functions including, obtaining a signal y over a channel, from a plurality of transmitters in communication with the receiver, wherein the signal y comprises data signals transmitted on a plurality of layers N, obtaining a concatenated matrix R, representing the channel between the plurality of transmitters and the receiver, wherein the concatenated matrix R cis obtained based on an estimated channel matrix H, and determining an ordered list [symbol] , based at least on the signal y and the obtained concatenated matrix R, wherein the ordered list is the list of N-dimensional vectors and each vector is a candidate constellation point for the transmitted data signal based on a predefined metric, wherein the determining the ordered list [symbol] comprises a List Search Block (LSB), wherein the LSB is configured to implement a Machine Learning (ML) algorithm. The usage of the LSB in the receiver improves the receiver performance in terms of block error rate (BLER) using low decoding latency and hardware power consumption.

In one embodiment, the concatenated matrix R may be obtained by a QR decomposition of the estimated channel matrix H.

In some embodiments of the present invention, the non-transitory computer-readable medium includes instructions for causing the processor to determine the ordered list [symbol] , may perform functions including determining an ordered list [symbol] _{N}, at a root layer of the plurality of layers, and means for determining a plurality of ordered lists [symbol] ₗ for other layers of the plurality of layers, wherein each ordered list [symbol] ₗ being determined may be based on the ordered list [symbol] ₗ₊₁, where l=N−1, N−2, . . . 1.

In one embodiment, determining the ordered list [symbol] _{N}, at the root layer, may comprise means for obtaining one or more input parameters, wherein the one or more input parameters may comprise at least an N^{th} element of the signal y, the constellation size M, and a required number of surviving candidates K_{N}, means for determining a plurality of partial symbol vector, wherein the determined partial symbol vector are the K_{N} surviving candidates for the root layer, based at least on the one or more input parameters, means for determining a first smallest possible window using a trained ML model, wherein the first smallest possible window comprises a plurality of constellation points K′_{N} for a signal y′ derived from N^{th} element of the signal y, wherein the plurality of constellation points K′_{N} may comprise the K_{N} closest constellation points to the signal y′, means for determining partial Euclidean distances (PEDs) between the signal y′ and each of K′_{N} constellation points in the first smallest possible window, and means for sorting the plurality of the plurality of constellation points K′_{N} based on the determined PEDs, and thereby determining the ordered list [symbol] _{N}. In one embodiment, the K_{N} surviving candidates may refer to one or more survivors in root layer i.e. layer N.

In one embodiment, the determined partial Euclidean distances associated with the plurality of constellation points K′_{N} in the ordered list [symbol] _{N}, may be stored in a list [symbol] _{N}.

Further, the non-transitory computer-readable medium includes instructions for determining the ordered lists [symbol] ₗ, for the other layers of the plurality of layers N, may comprise, obtaining one or more input parameters, wherein the one or more input parameters comprise at least an l^{th} element of the signal y, a constellation size M, and a required number of surviving candidates Kₗ for layer l, where l=N−1, N−2, . . . 1, obtaining an ordered list [symbol] ₗ and a list [symbol] ₗ from the surviving candidate in the ordered list [symbol] ₗ₊₁, where l=N−1, N−2, . . . 1, determining a closest constellation point for each surviving candidate in the ordered list [symbol] ₗ₊₁, determining a partial symbol vector for each determined closest constellation point, determining partial Euclidean distances (PEDs) based on the determined partial symbol vectors, sorting the ordered list [symbol] ₗ₊₁, wherein the ordered list [symbol] ₗ₊₁ is sorted in ascending order of determined PEDs, determining a smallest possible window, using the trained ML model, for each element in the sorted ordered list [symbol] ₗ₊₁, wherein the smallest possible window comprises a plurality of constellation points K_{l,i},wherein i=1, 2, . . . , Kₗ₊ₗ, determining partial Euclidean distances (PEDs) between a function of the l^{th} element of the signal y and each of the plurality of constellation points K_{l,i} and sorting the plurality of constellation points K_{l,i} in the smallest possible window based on the determined PEDs; and thereby determining the ordered list [symbol] ₗ.

In one embodiment, the determined partial Euclidean distances associated with plurality of constellation points K_{l,i} in the ordered list [symbol] ₗ may be stored in a list [symbol] ₗ. Further, the smallest possible window for the Kₗ surviving candidates is represented by a class indicated by integers L_{y′}, R_{y′}, B_{y′}, and T_{y′}, wherein L_{y′} represents a number of constellation points to the left of the closest constellation point in the smallest possible window, R_{y′} represents a number of constellation points to the right of the closest constellation point in the smallest possible window, B_{y′} represents a number of constellation points to the bottom of the closest constellation point in the smallest possible window, and T_{y′} represents a number of constellation points to the top of the closest constellation point in the smallest possible window.

Further, the non-transitory computer-readable medium includes instructions for performing Log-Likelihood ratio (LLR) computation on the determined ordered list [symbol] . Further, the non-transitory computer-readable medium includes instructions for pre-processing the signal y using one or more pre-processing techniques, wherein the one or more pre-processing techniques comprise at least noise-whitening technique and QR decomposition technique.

In another embodiment, the non-transitory computer-readable medium includes instructions for configuring the receiver to train the ML model based at least on a training data set with input features which are functions of a one-dimensional complex-valued signal y, the constellation size M, and the number of surviving candidates K_{N}.

Altogether, the embodiments described herewith provides several advantages. In particular,
The usage of the LSB in the receiver improves the receiver performance in terms of block error rate (BLER) using low decoding latency and hardware power consumption.
The usage of pre-trained ML block eliminates the need to calculate the distance to all the M constellation points. Such a use of the pre-trained ML block facilitates the reduction in computation complexities.
The usage of ML block improves the throughput of the MU-MIMO communication system.
The usage of the LSB in the receiver facilitates efficient simultaneous communication with multiple users.
The usage of the LSB in the receiver facilitates a reduced complexity decoder with a near optimal error performance for all channel conditions.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include such aspects and their equivalents.

### BRIEF DESCRIPTION OF THE DRAWINGS

Further embodiments, details, advantages, and modifications of the present embodiments will become apparent from the following detailed description of the embodiments, which is to be taken in conjunction with the accompanying drawings, wherein:

FIG. 1 illustrates a high level block diagram showing an operation in a K-best sphere decoder, according to an embodiment of the subject matter described herein.

FIG. 2 illustrates a block diagram showing uplink transmission in a 5G multiple input multiple output (MU-MIMO) communication system, according to an embodiment of the subject matter described herein.

FIG. 3 illustrates a block diagram showing a joint receiver/equalizer, according to an embodiment of the subject matter described herein.

FIG. 4 illustrates a block diagram showing a list-search operation in a layer, according to an embodiment of the subject matter described herein.

FIG. 5 illustrates a block diagram showing a pre-trained ML block, according to an embodiment of the subject matter described herein.

FIG. 6 illustrates an example of an 18-point window showing a smallest possible window of constellation points, according to an embodiment of the subject matter described herein.

FIG. 7 illustrates a flowchart showing a root layer computation in a multiple input multiple output (MU-MIMO) communication system, according to an embodiment of the subject matter described herein.

FIG. 8 illustrates a flowchart showing other layer N-i computation, in a multiple input multiple output (MU-MIMO) communication system, according to an embodiment of the subject matter described herein.

FIG. 9A illustrates a graph 900A showing a comparison between a Minimum Mean Square Error-Interference Rejection Combining (MMSE-IRC) and the proposed algorithm for Modulation and Coding Scheme (MCS)=16, according to another embodiment of the subject matter described herein.

FIG. 9B illustrates a graph 900B showing a comparison between a Minimum Mean Square Error-Interference Rejection Combining (MMSE-IRC) and the proposed algorithm for Modulation and Coding Scheme (MCS)=28, according to another embodiment of the subject matter described herein.

FIG. 9C illustrates graphs 900C and 900D showing a comparison between a Minimum Mean Square Error-Interference Rejection Combining (MMSE-IRC) and the proposed algorithm for Modulation for 2 UEs and Modulation and Coding Scheme (MCS)=16, according to another embodiment of the subject matter described herein.

FIG. 10 illustrates a block diagram showing one or more components of an apparatus, according to one example embodiment of the subject matter described herein.

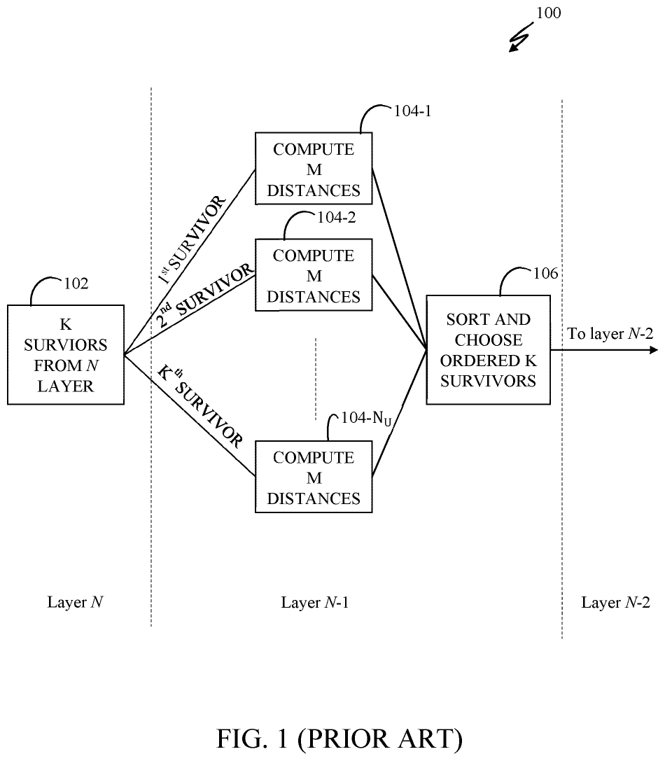

### DETAILED DESCRIPTION

Some embodiments of this disclosure, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to the listed item or items.

It should also be noted that as used herein and in the appended claims, the singular forms “a,” “an,” and “the” include plural references unless the context clearly dictates otherwise. Although any apparatus and method similar or equivalent to those described herein can be used in the practice or testing of embodiments of the present disclosure, the apparatus and methods are now described.

Embodiments of the present disclosure will be described more fully hereinafter with reference to the accompanying drawings in which like numerals represent like elements throughout the several figures, and in which embodiments are shown. Embodiments of the claims may, however, be embodied in many different forms and should not be construed as limited to the embodiments set forth herein. The examples set forth herein are non-limiting examples and are merely examples among other possible examples.

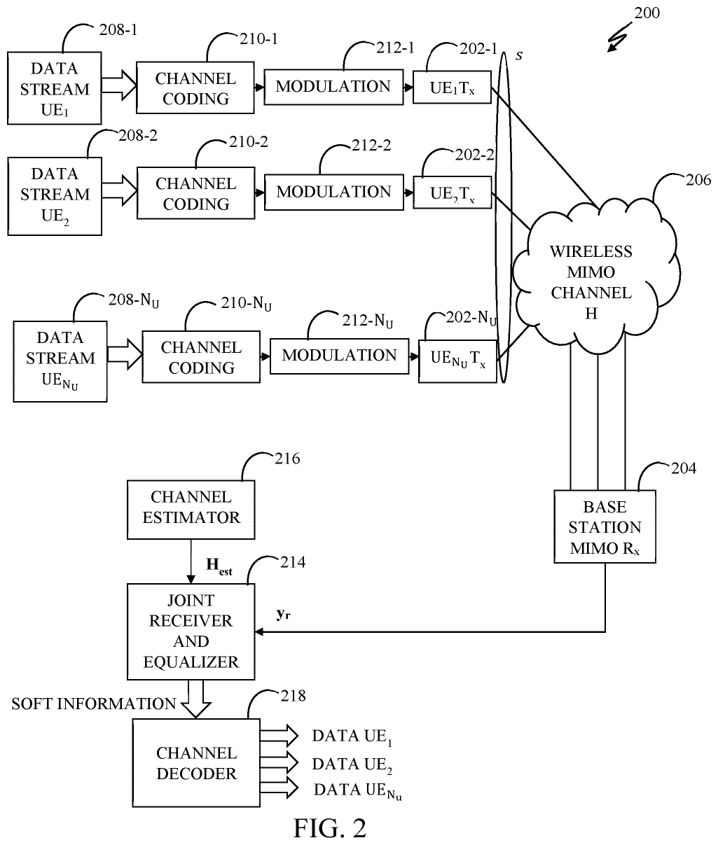

An embodiment of the present disclosure and its potential advantages are understood by referring to FIGS. 2 through 10 of the drawings, like numerals being used for like and corresponding parts of the various drawings.

FIG. 2 illustrates a block diagram showing an uplink transmission in a 5G multiple input multiple output (MU-MIMO) communication system 200, according to an embodiment. The MU-MIMO communication system 200 may comprise a plurality of user equipment transmitters 202-1, . . . 202-N_{U} and a receiver 204. Further, the plurality of user equipment transmitters 202 may include a user equipment 1 transmitter, user equipment 2 transmitter, . . . user equipment N_{U} transmitter. Hereinafter, the plurality of user equipment transmitters 202-1, . . . 202-N_{U} may be referred to as UE transmitter 202. It should be noted that the receiver 204 maybe hereinafter referred to as a base station MIMO receiver 204. In one embodiment, the receiver 204 maybe referred to as an apparatus.

Each one of the UE transmitter 202 may comprise at least one transmitting antenna and the base station MIMO receiver 204 may comprise at least one receiving antenna. In one example, each one of the UE transmitter 202 may comprise multiple transmitting antennas and the base station MIMO receiver 204 may comprise multiple receiving antennas. It should be noted that the UE transmitter 202 may be referred to as and/or may include some or all of the functionality of a user equipment (UE), mobile station (MS), terminal, an access terminal, a subscriber unit, a station, etc. Examples of the UE transmitter 202 may include, but are not limited to, cellular phones, smartphones, personal digital assistants (PDAs), wireless devices, electronic automobile consoles, sensors, or laptop computers. It should be noted that the base station MIMO receiver 204 maybe hereinafter referred to as a base station. In one embodiment, the base station may serve the UEs.

Further, each one of the UE transmitter 202 may communicate with the base station MIMO receiver 204, via a channel 206. In one embodiment, the channel 206 may be a wireless MIMO channel. Additionally, the channel 206 between the UE transmitter 202 and the base station MIMO receiver 204 may have a status or a state. Further, the status of the channel 206 may vary over time and may be described by one or more properties of the channel 206. It should be noted that properties of the channel 206 may, for example, comprise a channel gain, a channel phase, a signal-to-noise ratio (SNR), a received signal strength indicator (RSSI), or a transfer matrix. In one embodiment, the channel 206 may corrupt the signal being transmitted over the channel 206.

It will be apparent to one skilled in the art that the above-mentioned components of the MU-MIMO communication system 200 have been provided only for illustration purposes. The MU-MIMO communication system 200 may include a plurality of receivers as well, without departing from the scope of the disclosure.

Referring to FIG. 2, each one of the UE transmitter 202 may communicate with the base station MIMO receiver 204, via the channel 206. At first, the plurality of user equipment (UE) UE1, UE2, . . . UE_{N}_{_{U}} may transmit a plurality of data streams 208-1, . . . 208-N_{U}. Hereinafter, the plurality of data streams may be referred to as a data stream 208. In one embodiment, considering {UE₁, UE₂, . . . , UE_{N}_{ᵤ}} as the Nᵤ UE scheduled in a given transmission time interval (TTI) in a given cell in the uplink MU-MIMO mode. Further, Nᵣ is the number of received inputs at the base station MIMO receiver 204 and Nₜ^{(k)} be the number of transmit antennas at UEₖ, where k=1,2. . . Nᵤ and N=ΣₖNₜ^{(k)}.

Further, the data stream 208 from each of the plurality of UE may undergo a channel coding 210 of data streams 208. Additionally, the plurality of user equipment (UE) UE₁, UE₂, . . . UE_{N}_{_{U}} may undergo channel coding 210-1, . . . 210-N_{U} of data streams 208. Further, the channel coded data stream may undergo modulation 212 and maps the data stream 208 to modulation symbols. Furthermore, the plurality of user equipment (UE) UE₁, UE₂, . . . UE_{N}_{_{U}} may undergo modulation 212-1, . . . 212-N_{U} of data streams 208. In one embodiment, a signal constellation of order M may be used to modulate the data symbols for each data stream 208. Further, each of the plurality of modulated data stream may then be transmitted by their respective UE transmitter 202. In one embodiment, the modulation 212 may be performed according to Modulation and Coding Scheme (MCS). It should be noted that each one of the UE transmitter 202 may simultaneously receive data streams 208 from each one of the plurality of UE. As discussed above, each UE transmitter 202 may comprise a transmitting antenna, used for transmitting signals. In another embodiment, a block of modulated symbols may be transmitted over spatial streams.

In one embodiment, UEₖ transmits Nₜ^{(k)} number of modulated data streams. It should be noted that the data streams 208 may be referred to as layers. In one embodiment, at least two data streams may be received at the base station MIMO receiver 204, which may be from the same UE or different UE. Further, the data stream of UEₖ may be represented by sₖ∈Q^{N}^{ₜ}^{^{(k)}}^{×1}, where Q denotes the QAM constellation that the data symbols take values from. Further, the size of Q is M and an even power of 2. Further, the information regarding Q is known at the base station MIMO receiver 204. Further, the data streams 208 may be transmitted over the channel 206. In one embodiment, consider Hₖ to be the Nᵣ×Nₜ^{(k)} channel matrix representing the channel 206 between UEₖ and the base station MIMO receiver 204.

Based on the received data streams 208, the base station MIMO receiver 204 may send a signal yᵣ streams to a joint receiver and equalizer 214. Further, the joint receiver and equalizer 214 may receive a channel estimation signal from a channel estimator 216. Successively, the joint receiver and equalizer 214 may process the signal yᵣ and the channel estimation signal. In one embodiment, yᵣ may be represented as

yᵣ=Hs+nᵢₙₜ+n_{AWGN}
where yᵣ∈ [symbol] ^{N}^{ᵣ}^{×1} the signal received at the base station MIMO receiver 204 from all the UEs, H=[H₁ . . . H_{N}_{ᵤ}]∈ [symbol] ^{N}^{ᵣ}^{×N} is the estimated channel matrix H, n_{AWGN} is the additive white

Gaussian noise at the base station MIMO receiver 204, pint is the co-channel interference from other cells, and s=[s₁^{T}, s₂^{T}, . . . , s_{N}_{ᵤ}^{T}]^{T}−Q^{N×1} is the cumulative signal vector transmitted by all the Nᵤ UEs. It should be noted that the estimated channel matrix H may be referred as H est , as in practice, H is not known at the base station MIMO receiver 204. Further, hereinafter we assume that Hₑₛₜ=H.

Further, the processed information may be sent to a channel decoder 218. It should be noted that the processed information may be referred to as soft information. In one embodiment, the soft information may be based on the received signal yᵣ. The channel decoder 218 may classify the data related to each user equipment UE₁, UE₂, . . . UE_{N}_{_{U}}.

It will be apparent to one skilled in the art that above-mentioned uplink transmission scenario in a massive MIMO communication system 200 has been provided only for illustration purposes. In one embodiment, additional impairments may be added on top of this scenario due to hardware, without departing from the scope of the disclosure.

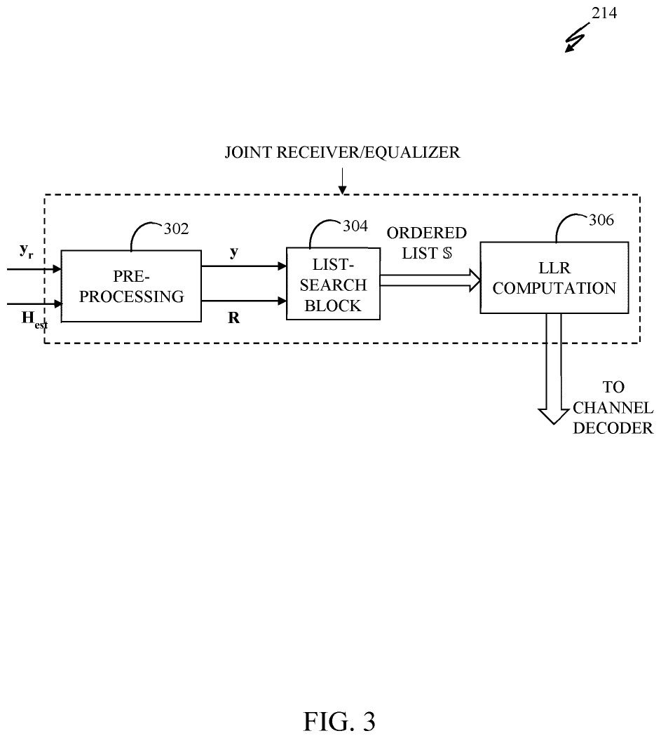

FIG. 3 illustrates a block diagram showing the joint receiver and equalizer 214, according to an embodiment of the subject matter described herein. Further, the joint receiver and equalizer 214 may comprise a pre-processing block 302, a list search block (LSB) 304, and a log-likelihood ratio (LLR) computation block 306.

At first, the joint receiver and equalizer 214 may receive the signal yᵣ and a channel estimation signal Hₑₛₜ. In one embodiment, yᵣ and Hₑₛₜ may be received by the pre-processing block 302. In one embodiment, the plurality of user equipment (UE) UE₁, UE₂, . . . UE_{N}_{_{U}} may be scheduled in a given transmission time interval (TTI) in a given cell in the uplink MU-MIMO mode. It should be noted that the UEs may be scheduled in the same resource blocks.

At the pre-processing block 302, Nᵣ is the number of received inputs at the base station MIMO receiver 204 and Nₜ^{(k)} is the number of transmit antennas at UEₖ, k=1,2, . . . , Nᵤ. In one embodiment, the pre-processing stage may comprise of noise-whitening and QR decomposition. At first, the noise-whitening of the signal yᵣ may suppress the effects of unwanted interference in the signal yᵣ. In one embodiment, noise-whitening may whiten the interference-cum-noise associated with the signal yᵣ, which may require an estimation of Interference Covariance Matrix, denoted as:

C= [symbol] {(yᵣ−Hs)(yᵣ−Hs)^{H}},

where C is obtained by averaging over pilot/reference symbol locations within a code block transmitted by the UEs. Further, noise whitening may comprise, performing Cholesky decomposition, denoted by C=LL^{H}. Thereafter, the received signal is multiplied by L⁻¹ to provide an effective received signal y̅=L⁻¹yᵣ and an effective channel matrix H̅=L⁻¹H. Thus, the effective received signal is y̅=H̅s+n̅, wherein n̅ is an interference term. It should be noted that, due to whitening, the effective noise and interference term Ft is transformed into white noise.

Thereafter, QR decomposition of H̅ is performed to obtain H̅=QR where Q∈ [symbol] ^{N}^{ᵣ}^{×N} is orthogonal and R∈ [symbol] ^{N×N} is an upper-triangular matrix. Further, received signal y may be computed, y [symbol] Q^{H}y̅, to get

y=Rs+n,y∈ [symbol] ^{N×1}, R∈ [symbol] ^{N×N}, s∈Q^{N×1}, n∈ [symbol] ^{N×1}

where n=Q^{H}n̅ continues to be white due to orthogonality of Q. In one embodiment, the signal y is obtained from the plurality of transmitters (202) in communication with the receiver (204), and signal y comprises data signals transmitted on a plurality of layers N. In one embodiment, the transmitted plurality of data signals is a vector of constellation points. In one embodiment, Q may be denoted by:

Q [symbol] {a+jb, a,b=−\sqrt{M}+1, −\sqrt{M}+3, . . . , \sqrt{M}−3, \sqrt{M}−1}, j=\sqrt{−1}.

As shown in FIG. 3, the processed signal y and the concatenated matrix R may be sent to the LSB 304. The concatenated matrix R may represent the channel between the plurality of transmitters 202 and the receiver 204, wherein the concatenated matrix R is obtained based on an estimated channel matrix H. It should be noted that the LSB 304 may use a quadrature amplitude modulation (QAM) constellation of size M. Further, the QAM constellation of size M may referring to the signal y may take M possible values depending on the bits to be mapped.

Further, the output of the LSB 304 may include an ordered list [symbol] . The ordered list [symbol] may be defined as:

[symbol]

={sᵢ∈Q^{N×1}, i=1,2, . . . , K|d(s₁)≤d(s₂)≤, . . . , ≤d(s_{K})}

where ∀s∈ [symbol] , ∀ś∉ [symbol] , d(s)≤d(ś), d(s) [symbol] ∥y−Rs∥, the K vectors belonging to Q^{N×1} with the least distance metrics given by d(s), and if d(sⱼ)=d(sₖ), considering sⱼ<sₖ if j<k. In one embodiment, for a received signal y [symbol] [y₁, y₂, . . . , y_{N}]^{T}, the associated vector s [symbol] [s₁, s₂, . . . , s_{N}]^{T}, and r_{i,j} denoting the (i, j)^{th} element of R. It should be noted that R is based on a channel estimate. Further, a partial received vector may be represented by y_{i:N} [symbol] [yᵢ, . . . , y_{N}]^{T} and a partial symbol vector may be represented by s_{i:N} [symbol] [s₁, . . . , s_{N}]^{T}, where 1≤i≤N. Furthermore, R_{i:N} denote the submatrix of R representing rows i to N, columns i to N and r_{i:N} [symbol] [r_{i,i}, rᵢ₊₁, . . . , r_{i,N}] denotes the sub-vector of row i of R consisting of elements from columns i to N. Thus, a partial Euclidean distance (PED) at Layer i is denoted by:

δ(s_{i:N})=∥y_{i:N}−R_{i:N}s_{i:N}∥.

which follows d(s)=δ(s)

δ²(s_{i:N})=δ²(s_{i+1:N})+∥yᵢ−r_{i,i}sᵢ−rs_{i+1:N}ss_{i+1:N}∥²

It should be noted that the ordered list [symbol] may comprise constellation symbols with a smallest PEDs for a target layer. Further, the layers may be classified into a root layer and remaining layers. In one embodiment, for 10 users with one transmitting antenna each, the number of layers may be 10. Thus among the 10 layers, layer 10 may be considered as a root layer, layer 9 to layer 1 may be considered as remaining layers.

Further, for each layer 1, 1≤l<N, an ordered list [symbol] of partial symbol vectors with the Kₗ smallest PEDs based on the surviving partial symbol vectors from Layer N. It should be noted that the algorithm ends upon reaching layer 1, where a final ordered list of K₁=K symbol vectors is obtained as output. In one embodiment, an upper threshold for Kₗ may be pre-set and may be determined based on ∥r_{l,l}∥. The value of ∥r_{l,l}∥is inversely proportional to the value of Kₗ, for near optimal detection of the signal y.

Such usage of the LSB 304 in a receiver improves the receiver performance in terms of block error rate (BLER) using low decoding latency and hardware power consumption. Consequently, it should be noted that system throughput may be improved.

Further, the ordered list [symbol] may be transmitted to the LLR computation block 306. It should be noted that the ordered list [symbol] is a list of N-dimensional vectors and each vector is a candidate constellation point for the transmitted signal based on a predefined metric. It should be noted that the predefined metric is Euclidean norm of y-Rs, which is the difference between the signal vector y and Rs, where s is the candidate point

The output of the LLR computation block 306 may be referred to as soft information. Further, the soft information may be fed to the channel decoder 218. In one embodiment, the channel decoder 218 may be, but is not limited to, belief propagation decoding, polar list-decoding, Turbo decoder, or convolutional decoder. In one embodiment, the channel decoder 218 may decode signals corresponding to each UE. Furthermore, it should be noted that both the quality of the computed LLRs and the complexity increase with increasing values of candidate points. In one embodiment, for each symbol in the vector s may take value from an M-QAM, there may be a total of N log M bits transmitted at a time. Further, for [symbol] ⱼ⁺ denoting a set of all symbol vector s∈Q^{N×1} that may be mapped in a way corresponding to a j^{th} bit being 1 and [symbol] ⱼ⁻ denoting a set of all symbol vector s∈Q^{N×1} that may be mapped in a way corresponding to the j^{th} bit being 0. Then, the LLR for the j^{th} bit is computed as:

L(xⱼ|y)= [symbol] {∥y−Rs∥}− [symbol] {∥y−Rs∥}, j=1,2, . . . , N log M.

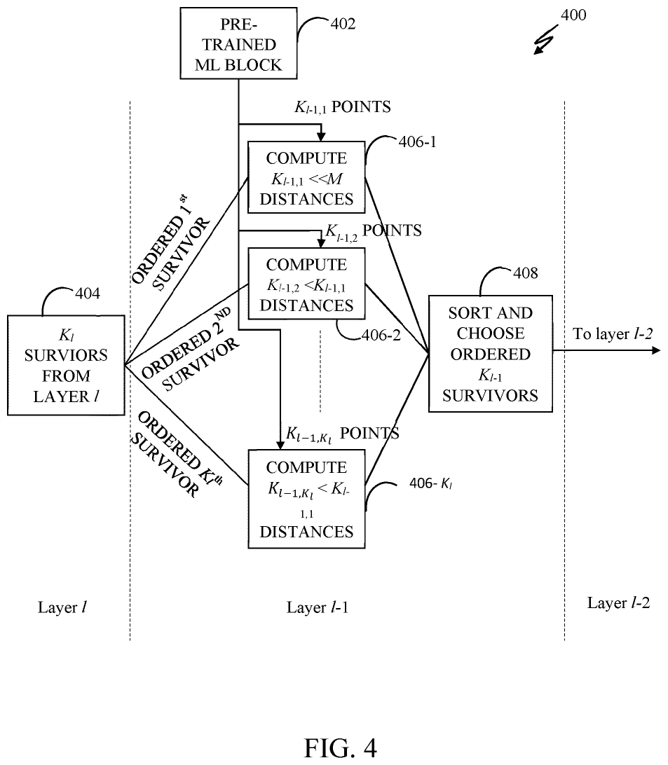

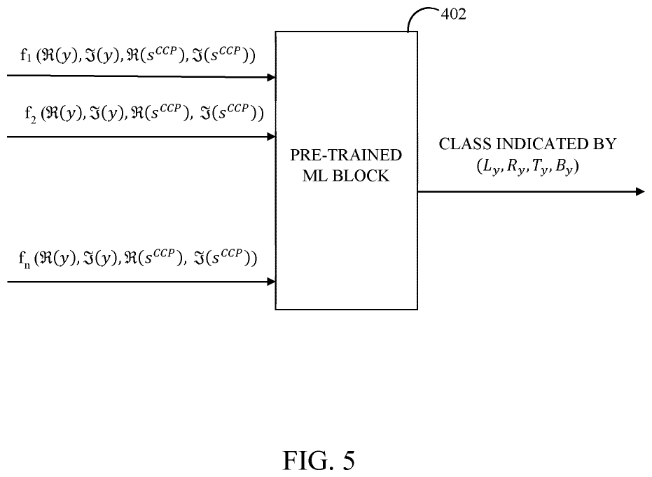

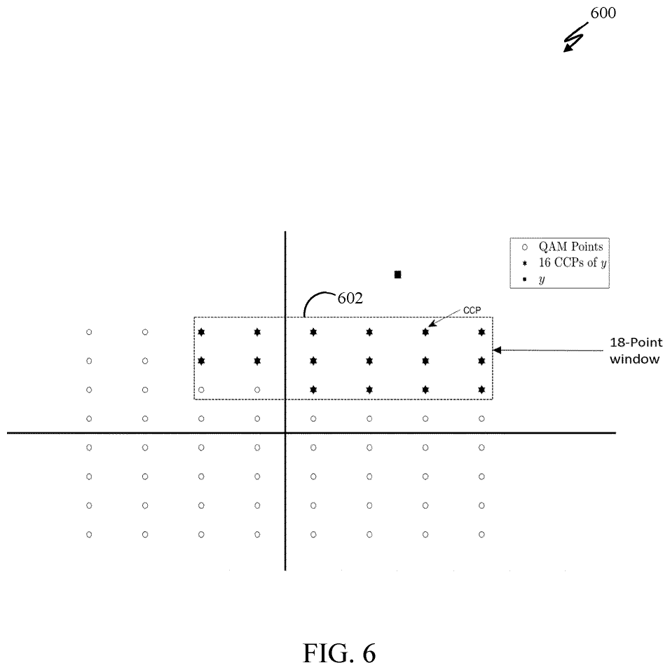

FIG. 4 illustrates a block diagram 400 showing a list-search operation in a layer for the proposed algorithm, according to an embodiment. FIG. 4 is explained in conjunction with FIG. 5 and FIG. 6.

It should be noted that in the disclosed operation may be performed in each layer in the proposed algorithm. The list-search operation is facilitated by use of a pre-trained Machine Learning (ML) block 402. Further, for N layers, the algorithm begins at layer N and sequentially progresses to layers N−1, N−2, . . . 1. In one embodiment, the layers l, l−1, and l−2 may be considered, where 1 is a general layer index and may take any value from N to 3. It should be noted that the root layer may be referred to as layer N and the remaining layers may be referred to as layer l+1 where l∈N−1, N−2, . . . 1, hereinafter.

At first, at layer l, Kₗ surviving candidates, at 404, may progress to the subsequent layer i.e. layer l−1. Further, the algorithm may select Kₗ surviving candidates in each layer by calculating less than KₗM distances, due the presence of the pre-trained ML black 402. In one embodiment, the Kₗ surviving candidates may refer to the partial symbol vectors. In addition to the Kₗ surviving candidates in each layer l, the pre-trained ML block 402, may provide a smallest possible window of constellation points, at each layer l−1. FIG. 5 a block diagram showing the pre-trained machine learning (ML) block 402, according to an embodiment. In one embodiment, the K_{N} surviving candidates may refer to the partial symbol vectors for the root layer.

The pre-trained ML block 402 may determine a smallest window at each layer of the proposed algorithm. It should be noted that the use of the pre-trained ML block 402 may provide a window of constellation points. Further, the size of the window is much smaller than M. In one embodiment, the pre-trained ML block 402 outputs the smallest possible window of points from an M-QAM constellation that contains the closed points to a candidate point corresponding to the signal y. In one embodiment, the pre-trained ML block 402 may output K_{l-1,1} points, at layer l−1, to compute, at 406-1 along with an ordered 1^{st} survivor from the previous layer l. Further, the pre-trained ML block 402 may output K_{l-1,2} points, at layer l−1, to compute, at 406-2, along with an ordered 2^{nd} survivor from the previous layer l. It should be noted that the process may continue till the pre-trained ML block 402 may output K_{l-1,K1} npoints, at layer l−1, to compute, at 406-Kₗ along with an ordered Kₗ^{th} survivor from the previous layer l.

In one embodiment, candidate point may be a complex point, comprising a real and an imaginary part. Further, the pre-trained ML block 402 may be trained offline to obtain the smallest window as a function of K and y. For a particular candidate point, K closest points from an M-QAM constellation Q may be identified. In accordance with the candidate point, closest constellation points may be determined from the M-QAM constellation Q. In one embodiment, the closest constellation points may be represented by a partial symbol vector of the closest constellation point S^{CCP}. In one embodiment, the pre-trained ML block 402 may be a classifier. It should be noted that for particular layer, the pre-trained ML block 402 may determine the smallest possible window using the parameters related to the received signal y and parameters related to the partial symbol vectors associated with the signal y. In one embodiment, for layer N, the pre-trained ML block 402 may determine the smallest possible window using the parameters related to N^{th} element of signal y and parameters related to the partial symbol vectors s_{N}.

In one embodiment, the pre-trained ML block 402 may determine the smallest possible window based on the n input parameters. Further, the n input parameters may be functions of the signal y and functions of partial symbol vector of the closest constellation point to y from Q, denoted by s^{CCP}. In one embodiment, at a layer l, for a candidate point yᵢ and closest constellation points by s^{CCP} (yₗ), K16, and 256 QAM defined as

QAM₂₅₆={a+jb|a, b∈{−15, −13, −11, . . . , 11, 13, 15}},

the n input parameters may be at least among a group of parameters consisting of, but not limited to real and imaginary functions of the signal y and s^{CCP}, like [symbol] (yₗ)|, |ℑ(yₗ)|, [symbol] (S^{CCP}(yₗ))|, |ℑ(S^{CCP}(yₗ))|, sign (| [symbol] (yₗ)|−| [symbol] (S^{CCP}(yₗ))|), sign(|ℑ(yₗ)|−|ℑ(S^{CCP}(yₗ))|, sign(| [symbol] (yₗ)|−15), sign(| [symbol] (yₗ)|−13), sig(|ℑ(yₗ)|−15), sign(|ℑ(yₗ)|−13), sign( [symbol] (yₗ−S^{CCP}(yₗ))), and sign(ℑ(yₗ−S^{CCP}(yₗ)))

It should be noted that the usage of pre-trained ML block 402 eliminates the need to calculate the distance to all the M constellation points. Such a use of the pre-trained ML block 402 facilitates the reduction in computation complexities.

Furthermore, the calculated less than KM distances may be sorted and chosen, at 408, to obtain an ordered list corresponding to the layer l−1. The sorted Kₗ₋₁ surviving candidates may then progress to the subsequent layer l−2. Further, the process may be repeated till the K surviving candidates reach layer l. In one embodiment, the layer l−2 may be referred to as the final layer or the last layer. Finally, K the surviving candidates of the of the final layer may provide the required ordered list [symbol] .

FIG. 6 illustrates an example 600 of an 18-point window 602 showing a smallest possible window of points, by the pre-trained ML block 402, from a 64-QAM constellation.

It should be noted that in FIG. 6, we have considered K=16 and for y=4.01 +10.99j (as the complex point) with M=64. Further, the 18-point window 602 is shown to contain 16 closest constellation points to the candidate point y. It should be noted that the 18-point window 602 maybe hereinafter referred to as smallest possible window 602. In one embodiment, candidate point y may be a complex point. Further, the pre-trained ML block 402 may be trained offline to obtain the smallest possible window 602 as a function of K_{N} and y. For a particular candidate point y, K_{N} closest points from an M-QAM constellation Q may be identified. In accordance with the candidate point y, closest constellation points may be determined among the M-QAM constellation Q. In one embodiment, the closest constellation points may be represented by S^{CCP}. Further, for each y, obtained as a function of each surviving candidate in layer l, the pre-trained ML block 402 may determine the smallest possible window 602 for each of the Kₗ surviving candidates which is represented by a class indicating L_{y}, R_{y}, B_{y}, and T_{y}, wherein L_{y} represents a number of constellation points on the left of the closest constellation point, R_{y} represents a number of constellation points on the right of the closest constellation point, B_{y} represents a number of constellation points on the bottom of the closest constellation point, and T_{y} represents a number of constellation points on the top of the closest constellation point. Further, it should be noted that there may be 81 different combinations of (L_{y}, R_{y}, T_{y}, B_{y}) for this dataset, so the label for each yᵢ is an integer that belongs to {0,1,2, . . . ,80}. Further, it should be noted that the integer is a positive integer.

In one embodiment, the output of the pre-trained ML block 402 may be referred to as a tuple. Further the tuple may be represented by (L_{y}, R_{y}, T_{y}, B_{y}). Further, the tuple may represent the smallest possible window 602 as R_{y} may represent the number of points in the smallest possible window 602 to the right of s^{CCP}(on the X-axis). For the example in FIG. 6, this value is 1. L_{y} may represent the number of points in the smallest possible window 602 to the left of s^{CCP} (on the X-axis). For the example in FIG. 6, this value is 4. T_{y} may represent the number of points in the smallest possible window 602 at the top of s^{CCP} (on the Y-axis). For the example in FIG. 5, this value is 0. B_{y} may represent the number of points in the smallest possible window 602 at the bottom of s^{CCP}(on the Y-axis). For the example in FIG. 6, this value is 2. Further, using the output of the ML block, a set of points in the smallest possible window 602 may be represented as:

[symbol]

={ [symbol] (s^{CCP})+2m+j(ℑ(s^{CCP})+2n)}

where m∈ [symbol] {−L_{y}, −L_{y}+1, . . . ,0, 1, . . . , R_{y}}, and n∈ [symbol] . {−B_{y}, −B_{y}+1, . . . ,0, 1, . . . , T_{y}}. It should be noted that the real and imaginary parts of each point in [symbol] may be subject to maximum value of \sqrt{M}−1 and a minimum value of \sqrt{M}+1.

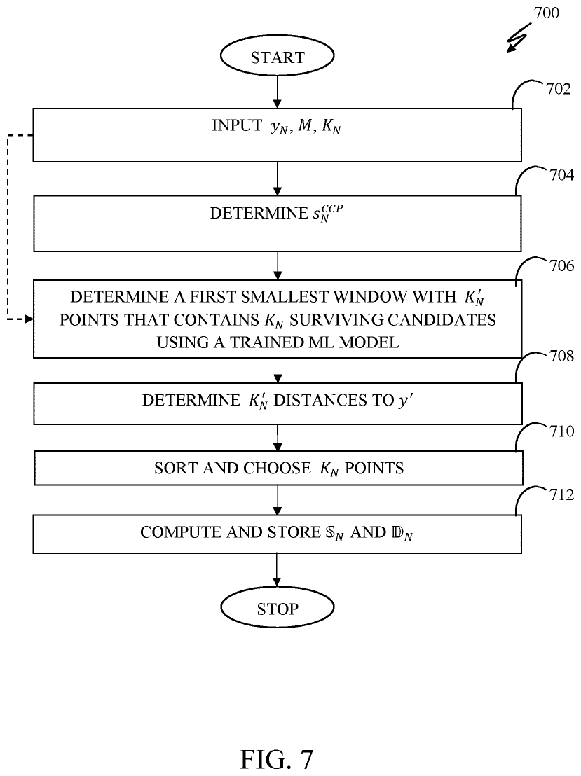

FIG. 7 illustrates a flowchart 700 showing a root layer computation in a multiple input multiple output (MU-MIMO) communication system, according to an embodiment. FIG. 7 is described in conjunction with FIG. 4.

At first, at the root layer, i.e. layer N, the input parameters associated to the signal y may be obtained, at step 702. In one embodiment, the input parameters may comprise at least a N^{th} element of the signal y, a constellation size M may be obtained along with the number of surviving candidates K_{N} among the constellation size M,. It should be noted that the N^{th} element of signal y corresponds to signal y at the root layer i.e. layer N. Further, a closest constellation point S_{N}^{CCP} to the signal y′, derived from the N^{th} element of signal y based at least on the input parameters, may be determined at step 704. After determining the partial symbol vector s_{N}^{CCP}, the pre-trained ML block 402 may determine a first smallest possible window of a plurality of constellation points K′_{N} for a signal y′ that contain the K_{N} surviving candidates, using a trained ML model, at step 706. The receiver is configured to train the ML model at least on a training data set with input features which are functions of a one-dimensional complex-valued signal y, the constellation size M, and the number of surviving candidates K_{N}. As discussed above, the input parameters i.e. a real and imaginary functions of the s^{CCP} for the pre-trained ML block 402 may be represented by

$$ℜ ( {s}_{N}^{CCP} ) = min \{ max ( 2 ⌊ \frac{ℜ ( {{y}^{'}}_{N} ) + 1}{2} ⌉ - 1 , - \sqrt{M} + 1 ) , \sqrt{M} - 1 \} ,$$

$$and$$

$$𝔍 ( {s}_{N}^{CCP} ) = min \{ max ( 2 ⌊ \frac{𝔍 ( {{y}^{'}}_{N} ) + 1}{2} ⌉ - 1 , - \sqrt{M} + 1 ) , \sqrt{M} - 1 \}$$

δ(s_{N})=∥y_{N}−r_{NN}s_{N}∥=∥r_{NN}∥∥ý_{N}−s_{N}∥ where ý_{N} [symbol] y_{N}/r_{NN}.

In one embodiment, the first smallest possible window may be determined by a design engineer. Based on the determined first smallest possible window, partial Euclidean distances (PEDs) between a candidate point of the signal y′ and each of the plurality of constellation points K′_{N} in the first smallest possible window may be determined, at step 708. The PED between the candidate point of the signal y and each of the plurality of constellation points in the first smallest possible window may be represented as

δₘᵢₙ [symbol] ∥r_{NN}∥∥ý_{N}−s_{N}^{CCP}∥=∥r_{NN}∥{square root over (( [symbol] (ý_{N}−s_{N}^{CCP}))²+(ℑ(ý_{N}−s_{N}^{CCP}))²)}

In one embodiment, the first smallest possible window may comprise the plurality of constellation points K′_{N} for a signal y′ derived from N^{th} element of the signal y. Further, the plurality of constellation points K′_{N} in the first smallest possible window based on the determined PEDs may be sorted and chosen, at step 710. Based on the sorted plurality of constellation points, an ordered list [symbol] _{N} may be computed and stored in [symbol] _{N}, at step 712. Further, [symbol] _{N}, may be represented by

[symbol]

_{N} [symbol] {s_{N}⁽ⁱ⁾∈Q, i=1,2, . . . , K_{N}|δ((s_{N}⁽¹⁾)≤, . . . , ≤δ(s_{N}^{(K}^{_{N}}⁾)≤δ(s), ∀s∉ [symbol] _{N}},

In one embodiment, the determined partial Euclidean distances associated with the plurality of constellation points K′_{N} in the ordered list [symbol] _{N} may be stored in [symbol] _{N}. In one embodiment, [symbol] _{N} may store the squares of the PEDs of all the elements of the ordered list [symbol] _{N}. Further, [symbol] _{N} may be represented by

[symbol]

_{N} [symbol] {δ²(s_{N}⁽ⁱ⁾), ∀s_{N}⁽ⁱ⁾∈ [symbol] _{N}}

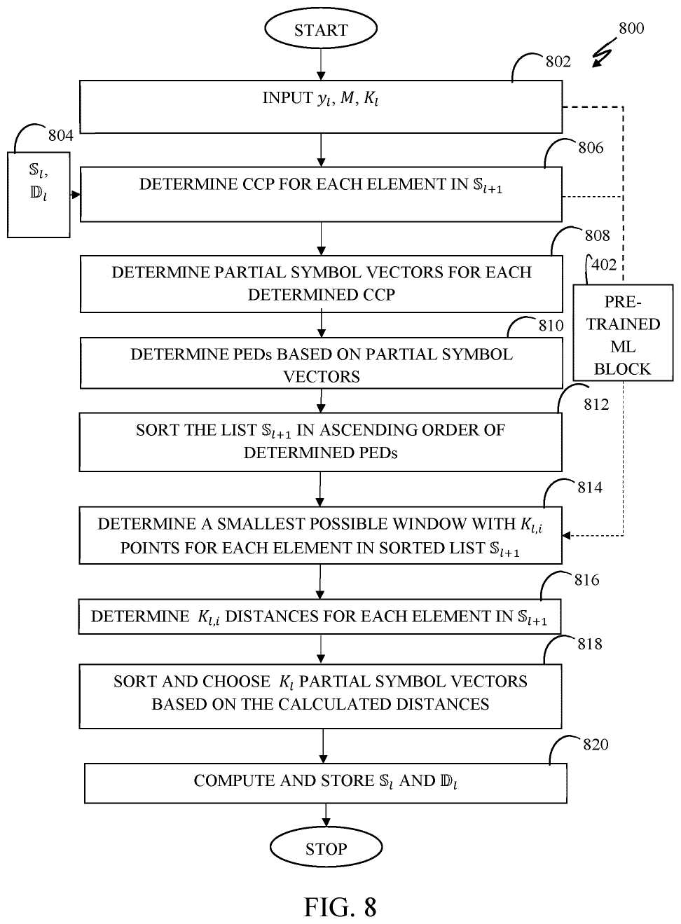

FIG. 8 illustrates a flowchart 800 showing other layer computations, in a multiple input multiple output (MU-MIMO) communication system, according to an embodiment. FIG. 8 is described in conjunction with FIG. 6.

At first, at the remaining layers, i.e. layers l, the input parameters associated to the signal y may be obtained. In one embodiment, the input parameters comprise at least an l^{th} element of signal y, the constellation size M may be obtained along with a required number of surviving candidates Kₗ among the constellation size M, at step 802. Further, the ordered list [symbol] ₗ and the list [symbol] ₗ of the plurality of constellation points in the first smallest possible window may be obtained from the surviving candidate in the ordered list [symbol] ₗ₊₁, at step 804. It should be noted that the ordered list [symbol] ₗ and the list [symbol] ₗ may be associated with a previous layer i.e. root layer in current scenario. Further, a closest constellation point for each of the Kₗ₊₁ surviving candidate in the ordered list [symbol] ₗ₊₁ may be determined, at step 806. In one embodiment, the Kₗ₊₁ surviving candidates in the ordered list [symbol] ₗ₊₁ may be sent to the pre-trained ML block 402. Further, for each of the closest constellation point, a partial symbol vector sₗ may be computed, at step 808. In one embodiment, the partial symbol vector s at the layer l may be represented by s_{l:N}⁽ⁱ⁾, and may be represented as

s_{l:N}⁽ⁱ⁾ [symbol] [sₗ^{CCP}(s_{l+1:N}⁽ⁱ⁾), (s_{l+1:N}⁽ⁱ⁾)^{T}]^{T}∈Q^{(N-l+1)×1}, i=1,2, . . . Kₗ₊₁,

Further, the square of PEDs may be computed and may be represented as

δ²(s_{l:N}⁽ⁱ⁾), for i=1,2, . . . , Kₗ₊₁

Thus

δ²(s_{l:N}⁽ⁱ⁾)=δ²(s_{l+1:N}⁽ⁱ⁾)+∥r_{l,l}∥²∥ýₗ(s_{l+1:N}⁽ⁱ⁾)−sₗ^{CCP}(s_{l+1:N}⁽ⁱ⁾∥².

For each of the closest constellation point, partial Euclidean distances (PEDs) between a candidate point of the l^{th} element of the signal y and each determined closest constellation point, based on the partial symbol vector, may be computed, at step 810. Further, the list [symbol] ₗ₊₁ may be sorted based on the determined PEDs, at step 812. The sorted Kₗ PEDs with i₁, i₂, . . . , i_{K}_{ₗ₊₁} may have the indices of the sorted PEDs, i.e.

$${δ}^{2} ( {s}_{l : N}^{( {i}_{1} )} ) \leq {δ}^{2} ( {s}_{l : N}^{( {i}_{2} )} ) \leq … \leq {δ}^{2} ( {s}_{l : N}^{( {i}_{{K}_{l + 1}} )} )$$

In one embodiment, a window of size K_{l,j}<<M, may be computed using the pre-trained ML block 402 with ýₗ(s_{l+1:N}⁽ⁱ^{ⱼ}⁾), sₗ^{CCP}(s_{l+1:N}⁽ⁱ^{ⱼ}⁾), √M, and Kₗ+1−j inputs. Further, for each constellation point sₖ∈Q, k=1, . . . , K_{l,j} in the window, the square of the PED may be computed as:

δ²([sₖ,(s_{l+1:N}⁽ⁱ^{ⱼ}⁾)^{T}]^{T})=δ²(s_{l+1:N}⁽ⁱ^{ⱼ}⁾)+∥r_{l,l}∥²∥ýₗ(s_{l+1:N}⁽ⁱ^{ⱼ}⁾)−sₖ∥².

In one embodiment, the computed plurality of constellation points in the smallest possible window may be sorted in ascending order. Based on the sorted plurality of constellation points, a window with K_{l,i} points for each element in the sorted list [symbol] ₗ₊₁, using the output of the pre-trained ML block 402, at step 814. Further, the distances between the K_{l,i} points for each element with index i in the sorted list and the candidate point of the l+1^{th} element of the signal y for the current layer may be computed, at step 816. Further, the plurality of closest constellation points K_{l,i} in the smallest possible window based on the determined PEDs may be sorted and chosen, at step 818. Based on the sorted plurality of constellation points, an ordered list [symbol] ₗ may be computed and stored, at step 820. In one embodiment, the [symbol] ₗ may be represented as

$${𝕊}_{l + 1} = {𝕊}_{l + 1} = {\{ {s}_{l + 1 : N}^{( {i}_{j} )} ∈ {Q}^{( N - 1 ) \times 1} \}}_{j = 1}^{{K}_{l + 1}} , and$$

$${𝕊}_{l} {=}^{def} \{ \begin{matrix}{s}_{l : N}^{( i )} ∈ {Q}^{( N - 1 + 1 ) \times 1} , i = 1 , 2 , … , {K}_{l} \\ {s}_{l + 1 : N}^{( i )} ∈ {𝕊}_{l + 1}\end{matrix} \vert \begin{matrix}δ ( {s}_{l : N}^{( i )} \leq , … , \leq δ ( {s}_{l : N}^{( {K}_{l} )} ) \\ \leq δ ( {s}_{l : N} ) , ∀ {s}_{l : N} ∉ {𝕊}_{l} and {s}_{l + 1 : N} ∈ {𝕊}_{l + 1}\end{matrix} \}$$

It should be noted that a list [symbol] ₗ may be created to store metrics associated with the ordered list [symbol] ₜ. In one embodiment, [symbol] ₗ may store the squares of the PEDs of all the elements of the ordered list [symbol] ₗ. In one embodiment, the [symbol] ₗ may be referred to as [symbol] ₗ and may be represented as

[symbol]

ₜ [symbol] {δ²(s_{l:N}⁽ⁱ⁾), ∀s_{l:N}⁽ⁱ⁾∈ [symbol] }.

Further, the above algorithm may be applied to all the remaining layers leading to the ordered list [symbol] represented by:

[symbol]

={sᵢ∈Q^{N×1}, i=1,2, . . . , K|d(s₁)≤d(s₂)≤, . . . , ≤d(s_{K})}.

In one embodiment, we consider a sklearn's decision tree classifier with criterion ‘gini’, class_weight=‘balanced’, and the remaining default parameters. It should be noted that the results for the classifier are tabulated in Table 1. Further, to calculate a window size of each of each predicted class, the predicted class may be mapped back to the tuple (L_{y}, R_{y}, T_{y}, B_{y}), and the window size may be calculated as (L_{y}+R_{y}+1)(T_{y}, +B_{y}+1). Further, a misclassification may occur when the predicted (L_{y}, R_{y}, T_{y}, B_{y}) does not match with an optimal (L_{y}, R_{y}, T_{y}, B_{y}) which represents the smallest window containing the 16 closest point to yᵢ.

TABLE 1

| K | 16 | |
|---|---|---|
| QAM constellation | 256-QAM | |
| Training data size | 1 Million | |
| Test data size | 160000 | |
| Test Accuracy | 99.82 | (289/160000 misclassifications) |
| Maximum number of closest | 1 (count = 128/289) | |
| constellation points (out of 16) not in | (indicates that the predicted window was | |
| the predicted window (across test | smaller than the optimal window) | |
| samples) | | |
| Minimum number of closest | 0 (count = 161/289) | |
| constellation points (out of 16) not in | (indicates that the predicted window was | |
| predicted window (across test | larger than the optimal window) | |
| samples) | | |
| Number of classes | 81 | |
| (window combinations) | | |
| Mean window size across classes | 20.70 | (class average) |
| Mean window size across test samples | 19.64 | (sample average) |

| | |
|---|---|
| Maximum window size | 25 |
| Minimum window size | 16 |
| Maximum depth of the tree | 26 (indicates the maximum number of |
| | decisions needed to for a sample) |
| Average depth of leaf node across test | 5.7 (average number of |
| samples | decisions needed per |
| | sample) |

In one embodiment, we consider MIMO communication in a 5G cellular network where a Base Station (BS) and UEs are equipped with multiple antennas. Further, the communication over the uplink (UL) channel where the BS receives the transmitted data from the UEs. Further, the scenario considers a massive MIMO system with transmitter and receiver beamforming. Table 2 lists the simulation parameters used for the evaluation:

TABLE 2

| Simulation Parameter | Value | |
|---|---|---|
| Carrier Frequency | 3.5 | GHz. |
| Bandwidth | 10 | MHz |
| Scenario | Uplink: single-user/multi-user | |
| BS Physical Antenna Configuration | 8 × 8 × 2 | |
| (M × N × P) | | |
| (d_{H}, d_{V}) | (0.5λ, 0.7λ) | |
| BS Antenna ports | 2/4/8 | |
| UE Physical Antenna Configuration | (1 × 1 × 2)/(2 × 1 × 2) | |
| (M × N × P) | | |
| UE Antenna ports | 2/4 | |
| Beamforming type | Grid of Beams (GoB) | |
| Channel Model | 3GPP CDL-A channel models | |
| MCS Values | 3GPP MCS Table 1/2 | |
| Channel Estimation type | Practical CE | |
| Receiver/Equalizer | IRC/Proposed Algorithm | |
| Simulation time | 5 | sec |

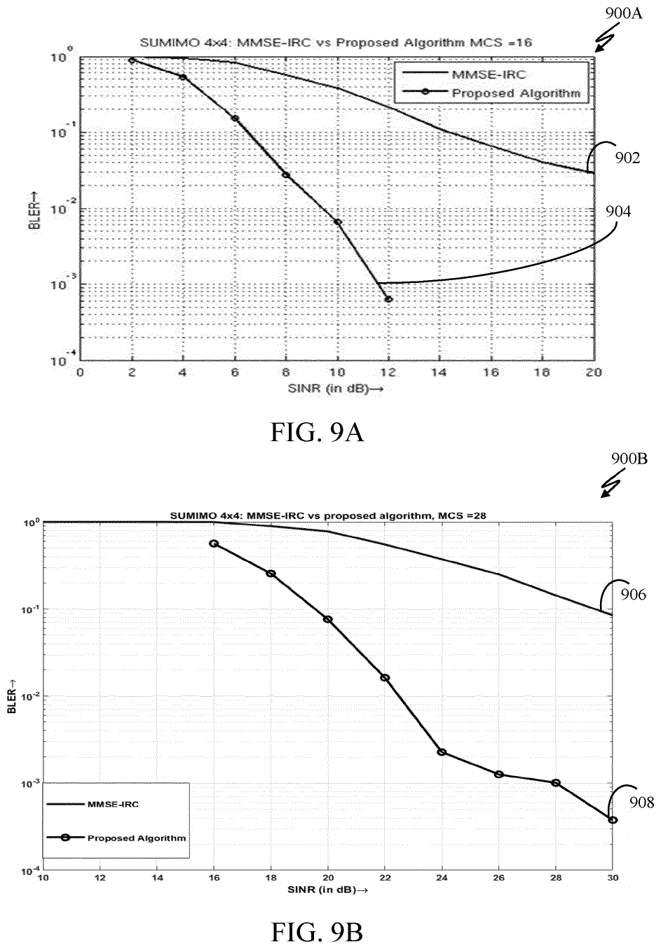

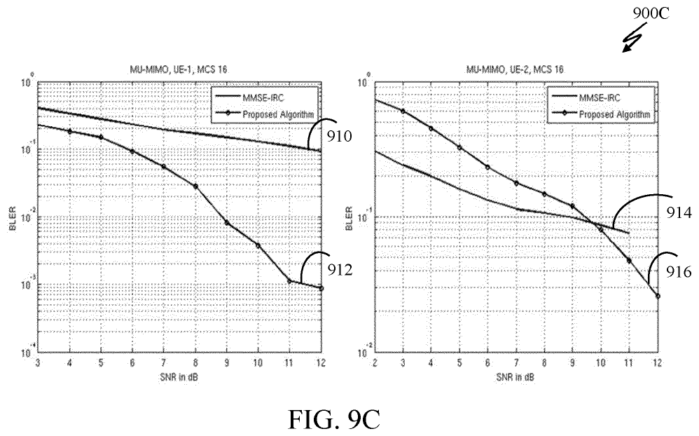

FIGS. 9A, 9B, and 9C illustrate graphs 900A, 900B, and 900C showing simulation results respectively, according to an embodiment. As shown in the graph 900A, a Minimum Mean Square Error-Interference Rejection Combining (MMSE-IRC) and the proposed algorithm for Modulation and Coding Scheme (MCS)=16. A line (shown by 902) represents a MMSE-IRC and a line (shown by 904) represents the proposed algorithm for Modulation and Coding Scheme (MCS)=16.

As shown in the graph 900B, a Minimum Mean Square Error-Interference Rejection Combining (MMSE-IRC) and the proposed algorithm for Modulation and Coding Scheme (MCS)=28. A line (shown by 906) represents a MMSE-IRC and a line (shown by 908) represents the proposed algorithm for Modulation and Coding Scheme (MCS)=28.

As shown in the graphs 900C and 900D, a comparison between a Minimum Mean Square Error-Interference Rejection Combining (MMSE-IRC) and the proposed algorithm for Modulation for UE 1 and UE 2, respectively, with Modulation and Coding Scheme (MCS)=16. A line (shown by 910) represents a MMSE-IRC and a line (shown by 912) represents the proposed algorithm

Modulation for UE 1 with Modulation and Coding Scheme (MCS)=16. Further, a line (shown by 914) represents a MMSE-IRC and a line (shown by 916) represents the proposed algorithm Modulation for UE 2 with Modulation and Coding Scheme (MCS)=16.

It will be apparent to one skilled in the art that above-mentioned joint decoding of UEs scheduled in a MU-MIMO within a single cell has been provided only for illustration purposes. In one embodiment, additional impairments may be added on top of this scenario due to hardware, without departing from the scope of the disclosure. The above-mentioned joint decoding of UEs scheduled in a MU-MIMO may be within multiple cells in either a same cell site (intra-site) or even across different cell sites (inter-site). In another embodiment, the joint decoding of UEs scheduled in a MU-MIMO using antennas of one or more than one cell (like in Cooperative Multipoint, CoMP) operation.

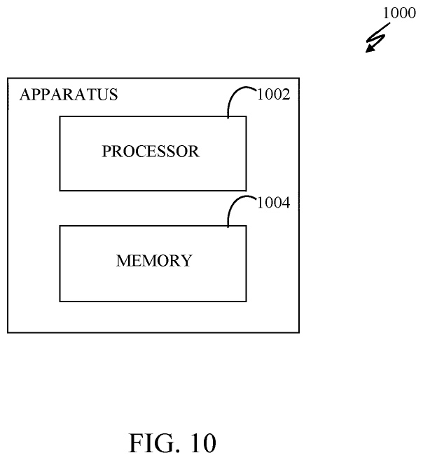

FIG. 10 is a block diagram showing one or more components of an apparatus 1000, according to an embodiment. The apparatus 1000 may include a processor 1002 and a memory 1004.

The processor 1002 includes suitable logic, circuitry, and/or interfaces that are operable to execute instructions stored in the memory to perform various functions. The processor 1002 may execute an algorithm stored in the memory for a receiver of a multiple input multiple output, MIMO, communication system 100. The processor 1002 may also be configured to decode and execute any instructions received from one or more other electronic devices or server(s). The processor 1002 may include one or more general-purpose processors (e.g., INTEL® or Advanced Micro Devices® (AMD) microprocessors) and/or one or more special-purpose processors (e.g., digital signal processors or Xilinx® System On Chip (SOC) Field Programmable Gate Array (FPGA) processor). The processor 1002 may be further configured to execute one or more computer-readable program instructions, such as program instructions to carry out any of the functions described in the description.

Further, the processor 1002 may make decisions or determinations, generate frames, packets or messages for transmission, decode received frames or messages for further processing, and other tasks or functions described herein. The processor 1002, which may be a baseband processor, for example, may generate messages, packets, frames or other signals for transmission via wireless transceivers. It should be noted that the processor 1002 may control transmission of signals or messages over a wireless network, and may control the reception of signals or messages, etc., via a wireless network (e.g., after being down-converted by wireless transceiver, for example). The processor 1002 may be (or may include), for example, hardware, programmable logic, a programmable processor that executes software or firmware, and/or any combination of these. Further, using other terminology, the processor 1002 along with the transceiver may be considered as a wireless transmitter/receiver system, for example.

The memory 1004 stores a set of instructions and data. Further, the memory 1004 includes one or more instructions that are executable by the processor to perform specific operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g. Microsoft Azure and Amazon Web Services, AWS), or other type of media/machine-readable medium suitable for storing electronic instructions.

It will be apparent to one skilled in the art that the above-mentioned components of the apparatus 1000 have been provided only for illustration purposes. In one embodiment, the apparatus 1000 may include an input device, output device etc. as well, without departing from the scope of the disclosure.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

The detailed description section of the application should state that orders of method steps are not critical. Such recitations would later support arguments that the step order in a method claim is not critical or fixed. Features that are described and/or illustrated with respect to one embodiment may be used in the same way or in a similar way in one or more other embodiments and/or in combination with or instead of the features of the other embodiments.

While the above embodiments have been illustrated and described, as noted above, many changes can be made without departing from the scope of the embodiments. For example, aspects of the subject matter disclosed herein may be adopted on alternative operating systems. Accordingly, the scope of the embodiments is not limited by the disclosure of the embodiment. Instead, the embodiments should be determined entirely by reference to the claims that follow.

1. A receiver of a multiple input multiple output, communication system, the communication system comprising a plurality of transmitters, and a communication channel, the receiver comprising:
at least one processor; and
at least one non-transitory memory storing instructions that, when executed with the at least one processor; cause the receiver to perform:
obtaining a signal y over the channel from the plurality of transmitters in communication with the receiver, wherein the signal y comprises data signals transmitted on a plurality of layers N;
obtaining a concatenated matrix R, representing the channel between the plurality of transmitters and the receiver, wherein the concatenated matrix R is obtained based on an estimated channel matrix H; and
determining an ordered list [symbol] , based at least on the signal y and the obtained concatenated matrix R, wherein the ordered list is a list of N-dimensional vectors and the vector is a candidate constellation point for the transmitted data signal based on a predefined metric;
wherein the ordered list [symbol] comprises a list search block wherein the instructions, when executed with the at least one processor, implement a machine learning algorithm.

2. The receiver according to claim 1, wherein the instructions, when executed with the at least one processor, cause the receiver to obtain the concatenated matrix R with a QR decomposition of the estimated channel matrix H.

3. The receiver according to claim 1, wherein the instructions, when executed with the at least one processor, cause the receiver to perform:
determining an ordered list [symbol] _{N}, at a root layer of the plurality of layers N; and
determining a plurality of ordered lists [symbol] ₗ for the other layers of the plurality of layers N,
wherein the ordered list [symbol] ₗ being determined is based on the ordered list [symbol] ₗ₊₁, here l=N−1, N−2, . . . , 1.

4. The receiver according to claim 1, wherein the instructions, when executed with the at least one processor, cause the receiver to perform:
obtaining one or more input parameters, wherein the one or more input parameters comprise at least an N^{th} element of the signal y, a constellation size M, and a number of surviving candidates K_{N};
determining a plurality of partial symbol vectors, wherein the determined partial symbol vectors are the K_{N} surviving candidates for the root layer, based at least on the one or more input parameters;
determining a first smallest possible window using a trained machine language model, wherein the first smallest possible window comprises a plurality of constellation points K′_{N} for a signal y′ derived from N^{th} element of the signal y, wherein the plurality of constellation points K′_{N} comprise the K_{N} closest constellation points to the signal y′;
determining partial Euclidean distances between the signal y′ and the plurality of constellation points K′_{N} in the first smallest possible window; and
sorting the plurality of constellation points K′_{N} based on the determined partial Euclidean distances, and thereby determining me oraerea list [symbol] _{N}.

5. The receiver according to claim 1, wherein the determined partial Euclidean distances associated with the plurality of constellation points K′_{N} in the ordered list [symbol] _{N}, are stored in a list [symbol] _{N}.

6. The receiver according to claim 1, wherein the first smallest possible window for the K_{N} surviving candidates is represented with a class indicated with integers L_{y}, R_{y}, B_{y}, and T_{y},
wherein L_{y} represents the number of constellation points to the left of the closest constellation point in the smallest possible window, R_{y} represents the number of constellation points to the right of the closest constellation point in the smallest possible window, B_{y} represents the number of constellation points below the closest constellation point in the smallest possible window, and T_{y} represents the number of constellation points above the closest constellation point in the smallest possible window.

7. The receiver according to claim 1, wherein the instructions, when executed with the at least one processor, cause the receiver to perform:
obtaining one or more input parameters, wherein the one or more input parameters comprise at least an l^{th} element of the signal y, the constellation size M, and a number of surviving candidates Kₗ for layer l, where 1=N−1, N−2, . . . ,1;
obtaining an ordered list [symbol] ₗ and a list [symbol] ₗ from the surviving candidate in the ordered list [symbol] ₗ₊₁, where l=N−1, N−2, . . . , 1;
determining a closest constellation point for the surviving candidate in the ordered list [symbol] ₗ₊₁;
determining a partial symbol vector for the determined closest constellation point;
determining partial Euclidean distances, based on the determined partial symbol vectors;
sorting the ordered list [symbol] ₗ₊₁ wherein the ordered list [symbol] ₗ₊₁ is sorted in ascending order of determined partial Euclidean distances;
determining a smallest possible window, using the trained machine language model, for the element in the sorted ordered list [symbol] ₗ₊₁, wherein the smallest possible window comprises a plurality of constellation points K_{l,i}, where i=1, 2, . . . , Kₗ₊₁;
determining partial Euclidean distances, between a function of the l^{th} element of the signal y and the plurality of constellation points K_{l,i}; and
sorting the plurality of constellation points K_{l,i} in the smallest possible window based on the determined partial Euclidean distances, and thereby determining the ordered list [symbol] ₗ.

8. The receiver according to claim 1, wherein the determined partial Euclidean distances associated with the plurality of constellation points K_{l,i}in the ordered list [symbol] ₗ, is stored in a list [symbol] ₗ, where l=N−1, N−2, . . . , 1.

9. The receiver according to any one of the preceding claims claim 1, wherein the smallest possible window for the Kₗ surviving candidates is represented with a class indicated with integers L_{y′}, R_{y′}, B_{y′}, and T_{y′}.
wherein L_{y′} represents a number of constellation points to the left of the closest constellation point in the smallest possible window, R_{y′} represents a number of constellation points to the right of the closest constellation point in the smallest possible window, B_{y′} represents a number of constellation points below the closest constellation point in the smallest possible window, and T_{y′} represents a number of constellation points above the closest constellation point in the smallest possible window.

10. The receiver according to claim 1, wherein the instructions, when executed with the at least one processor, cause the receiver to perform log-likelihood ratio computation on the determine [symbol] .

11. The receiver according to claim 1, wherein the instructions, when executed with the at least one processor, cause the receiver to perform pre-processing the signal y using one or more pre-processing techniques, wherein the one or more pre-processing techniques comprise at least noise-whitening technique and QR decomposition technique.

12. The receiver according to claim 1, wherein the instructions, when executed with the at least one processor, cause the receiver to perform training the machine language model based at least on a training data set with input features which are functions of a one-dimensional complex-valued signal y, the constellation size M, and the number of surviving candidates K_{N}.

13. A multi-user multiple input multiple output communication system, the multi-user multiple input multiple output communication system comprising a plurality of transmitters, a receiver, and a multiple input multiple output channel, wherein the receiver is implemented according to claim 1.

14. A method for decoding a signal y at a receiver in a multiple input multiple output communication system, the method comprising:
obtaining a signal y over a channel from a plurality of transmitters in communication with the receiver, wherein the signal y comprises data signals transmitted on a plurality of layers N;
obtaining a concatenated matrix R, representing the channel between the plurality of transmitters and the receiver, wherein the concatenated matrix R is obtained based on an estimated channel matrix H; and
determining an ordered list [symbol] , based at least on the signal y and the obtained concatenated matrix R, wherein the ordered list is a list of N-dimensional vectors and the vector is a candidate constellation point for the transmitted data signal based on a predefined metric,
wherein determining the ordered list [symbol] comprises a list search block configured to implement a machine learning algorithm.

15. The method of claim 14, wherein the concatenated matrix R is obtained with a QR decomposition of the estimated channel matrix H.

16. The method of claim 14, wherein determining the ordered list [symbol] further comprises:
determining an ordered list [symbol] _{N}, at a root layer of the plurality of layers N; and
determining a plurality of ordered lists [symbol] ₗ for other layers of the plurality of layers N,
wherein the ordered list [symbol] ₗ being determined is based on the ordered list [symbol] ₗ₊₁, where
l=N−1, N−2, . . , 1.

17. The method of claim 14, wherein determining the ordered list [symbol] _{N}, at the root layer, comprises:
obtaining one or more input parameters, wherein the one or more input parameters comprise at least an N^{th} element of the signal y, a constellation size M, and a number of surviving candidates K_{N};
determining a plurality of partial symbol vectors, wherein the determined partial symbol vectors are the K_{N} surviving candidates for the root layer, based at least on the one or more input parameters;
determining a first smallest possible window using a trained machine language model, wherein the first smallest possible window comprises a plurality of constellation points K′_{N} for a signal y′ derived from N^{th} element of the signal y, wherein the plurality of constellation points K′_{N} comprise the K_{N} closest constellation points to the signal y′;
determining partial Euclidean distances between the signal y′ and the plurality of constellation points K′_{N} in the first smallest possible window; and
sorting the plurality of constellation points K′_{N} based on the determined partial Euclidean distances, and thereby determining the ordered list [symbol] _{N}.

18. The method of claim 14, wherein determining the plurality of ordered lists [symbol] ₗ, for the other layers of the plurality of layers, comprises:
obtaining one or more input parameters, wherein the one or more input parameters comprise at least an l^{th} element of the signal y, a constellation size M, and a number of surviving candidates Kₗ for layer l, where l=N−1, N−2, . . . , 1;
obtaining an ordered list [symbol] ₗ and a list [symbol] ₗ from the surviving candidate in the ordered list [symbol] ₗ₊₁, where l=N−1, N−2, . . , 1;
determining a closest constellation point for the surviving candidate in the ordered list [symbol] ₗ₊₁;
determining a partial symbol vector for the determined closest constellation point;
determining partial Euclidean distances based on the determined partial symbol vectors;
sorting the ordered list [symbol] ₗ₊₁ wherein the ordered [symbol] ₗ₊₁ is sortea in ascenaing order of determined partial Euclidean distances;
determining a smallest possible window, using the trained machine language model, for the element in the sorted ordered list [symbol] ₗ₊₁, wherein the smallest possible window comprises a plurality of constellation points K_{l,i}, where i=1, 2, . . . , Kₗ₊₁;
determining partial Euclidean distances between a function of the l^{th} element of the signal y and the plurality of constellation points K_{l,i}; and
sorting the plurality of constellation points K_{l,i} in the smallest possible window based on the determined partial Euclidean distances, and thereby determining the ordered list [symbol] ₗ.

19. The method of claim 14, wherein the receiver is configured to train the machine language model at least on a training data set with input features which are functions of a one-dimensional complex-valued signal y, the constellation size M, and the number of surviving candidates K_{N}.

20. A non-transitory program storage device readable with an apparatus, tangibly embodying a program of instructions executable with the apparatus for performing operations for a receiver of a multiple input multiple output communication system, the operations including:
obtaining a signal y over a channel, from a plurality of transmitters in communication with the receiver, wherein the signal y comprises data signals transmitted on a plurality of layers N;
obtaining a concatenated matrix R, representing the channel between the plurality of transmitters and the receiver, wherein the concatenated matrix R is obtained based on an estimated channel matrix H; and
determining an ordered list [symbol] , based at least on the signal y and the obtained concatenated matrix R, wherein the ordered list is a list of N-dimensional vectors and the vector is a candidate constellation point for the transmitted data signal based on a predefined metric,
wherein the determining the ordered list [symbol] comprises a list search block configured to implement a machine learning algorithm.
